(19) United States
(12) Patent Application Publication
(10) Pub. No.: US 2013/0101158 A1
(43) Pub. Date: Apr. 25, 2013

(54) DETERMINING DIMENSIONS ASSOCIATED WITH AN OBJECT

(71) Applicants: Ryan A. Lloyd, Apple Valley, MN (US); Scott McCloskey, Minneapolis, MN (US)

(72) Inventors: Ryan A. Lloyd, Apple Valley, MN (US); Scott McCloskey, Minneapolis, MN (US)

(73) Assignee: Honeywell International Inc., Morristown, NJ (US)

(21) Appl. No.: 13/278,559

(22) Filed: Oct. 21, 2011

(51) Int. Cl. G06K 9/00

(52) U.S. Cl. 382/103

(57) ABSTRACT

Devices, methods, and systems for determining dimensions associated with an object are described herein. One system includes a range camera configured to produce a range image of an area in which the object is located, and a computing device configured to determine the dimensions of the object based, at least in part, on the range image.

### TECHNICAL FIELD

The present disclosure relates to devices, methods, and systems for determining dimensions associated with an object.

### BACKGROUND

An object, such as, for example, a box or package to be shipped by a shipping company, may have particular dimensions (e.g., a particular length, width, height, diameter, etc.) associated therewith. The dimensions associated with (e.g., of) the object may be used, for example, by the shipping company to determine the cost (e.g., bill) for shipping the object and/or to allocate space for the object in a shipping vehicle (e.g., a truck), among other uses.

In some previous approaches, the dimensions of the object were determined by the customer or an employee of the shipping company, who would manually measure (e.g., with a tape measure) the object, and then manually input (e.g., enter) the measurements into a computing system of the shipping company. However, this approach for determining dimensions of an object is error-prone, time-consuming and/or decreases the productivity of the employee, because, for example, it involves the employee physically contacting the object to measure its dimensions. Additionally, the employee's measurements may be incorrect and/or inexact, and/or the employee may accidentally enter the wrong measurements into the computing system, which would result in an erroneous determination of the object's dimensions.

### BRIEF DESCRIPTION OF THE DRAWINGS

FIG. 1 illustrates a system for determining dimensions associated with an object in accordance with one or more embodiments of the present disclosure.

FIG. 2 illustrates a method for determining dimensions associated with an object in accordance with one or more embodiments of the present disclosure.

### DETAILED DESCRIPTION

Devices, methods, and systems for determining dimensions associated with an object are described herein. For example, one or more embodiments include a range camera configured to produce a range image of an area in which the object is located, and a computing device configured to determine the dimensions of the object based, at least in part, on the range image.

One or more embodiments of the present disclosure can increase the automation involved in determining the dimensions associated with (e.g., of) an object (e.g., a box or package to be shipped by a shipping company). For example, one or more embodiments of the present disclosure may not involve an employee of the shipping company physically contacting the object during measurement (e.g., may not involve the employee manually measuring the object and/or manually entering the measurements into a computing system) to determine its dimensions.

Accordingly, one or more embodiments of the present disclosure can decrease and/or eliminate the involvement of an employee of the shipping company in determining the dimensions of the object. This can, for example, increase the productivity of the employee, decrease the amount of time involved in determining the object's dimensions, reduce and/or eliminate errors in determining the object's dimensions (e.g., increase the accuracy of the determined dimensions), and/or enable a customer to check in and/or pay for a package's shipping at an automated station (e.g., without the help of an employee), among other benefits.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

As used herein, “a” or “a number of” something can refer to one or more such things. For example, “a number of planar regions” can refer to one or more planar regions.

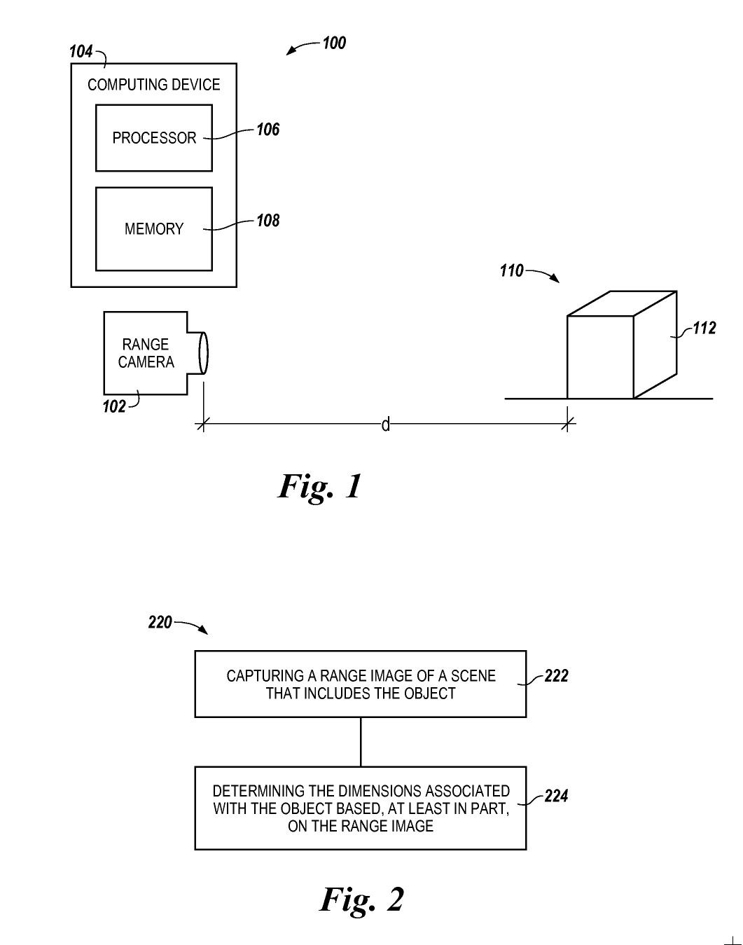

FIG. 1 illustrates a system 100 for determining dimensions associated with (e.g., of) an object 112 in accordance with one or more embodiments of the present disclosure. In the embodiment illustrated in FIG. 1, object 112 is a rectangular shaped box (e.g., a rectangular shaped package). However, embodiments of the present disclosure are not limited to a particular object shape, object scale, or type of object. For example, in some embodiments, object 112 can be a cylindrical shaped package. As an additional example, object 112 could be a rectangular shaped box with one or more arbitrarily damaged faces.

As shown in FIG. 1, system 100 includes a range camera 102 and a computing device 104. In the embodiment illustrated in FIG. 1, range camera 102 is separate from computing device 104 (e.g., range camera 102 and computing device 104 are separate devices). However, embodiments of the present disclosure are not so limited. For example, in some embodiments, range camera 102 and computing device 104 can be part of the same device (e.g., range camera 102 can include computing device 104, or vice versa). Range camera 102 and computing device 104 can be coupled by and/or communicate via any suitable wired or wireless connection (not shown in FIG. 1).

As shown in FIG. 1, computing device 104 includes a processor 106 and a memory 108. Memory 108 can store executable instructions, such as, for example, computer readable instructions (e.g., software), that can be executed by processor 106. Although not illustrated in FIG. 1, memory 108 can be coupled to processor 106.

Memory 108 can be volatile or nonvolatile memory. Memory 108 can also be removable (e.g., portable) memory, or non-removable (e.g., internal) memory. For example, memory 108 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory.

Further, although memory 108 is illustrated as being located in computing device 104, embodiments of the present disclosure are not so limited. For example, memory 108 can also be located internal to another computing resource (e.g., enabling computer readable instructions to be downloaded over the Internet or another wired or wireless connection).

In some embodiments, range camera 102 can be part of a handheld and/or portable device, such as a barcode scanner. In some embodiments, range camera 102 can be mounted on a tripod.

Range camera 102 can produce (e.g., capture, acquire, and/or generate) a range image of an area (e.g., scene). Range camera 102 can produce the range image of the area using, for example, structured near-infrared (near-IR) illumination, among other techniques for producing range images.

The range image can be a two-dimensional image that shows the distance to different points in the area from a specific point (e.g., from the range camera). The distance can be conveyed in real-world units (e.g., metric units such as meters or millimeters), or the distance can be an integer value (e.g., 11-bit) that can be converted to real-world units. The range image can be a two-dimensional matrix with one channel that can hold integers or floating point values. For instance, the range image can be visualized as different black and white shadings (e.g., different intensities, brightnesses, and/or darknesses) and/or different colors in any color space (e.g., RGB or HSV) that correspond to different distances between the range camera and different points in the area.

For example, range camera 102 can produce a range image of an area (e.g., area 110 illustrated in FIG. 1) in which object 112 is located. That is, range camera 102 can produce a range image of an area that includes object 112.

Range camera 102 can be located a distance d from object 112 when range camera 102 produces the range image, as illustrated in FIG. 1. Distance d can be, for instance, 0.75 to 5.0 meters. However, embodiments of the present disclosure are not limited to a particular distance between range camera 102 and object 112.

The range image produced by range camera 102 can be visualized as black and white shadings corresponding to different distances between range camera 102 and different portions of object 112. For example, the darkness of the shading can increase as the distance between range camera 102 and the different portions of object 112 decreases (e.g., the closer a portion of object 112 is to range camera 102, the darker the portion will appear in the range image). Additionally and/or alternatively, the range image can be visualized as different colors corresponding to the different distances between range camera 102 and the different portions of object 112.

Computing device 104 can determine the dimensions (e.g., the length, width, height, diameter, etc.) of object 112 based, at least in part, on the range image produced by range camera 102. For instance, processor 106 can execute executable instructions stored in memory 108 to determine the dimensions of object 112 based, at least in part, on the range image.

For example, computing device 104 can identify a number of planar regions in the range image produced by range camera 102. The identified planar regions may include planar regions that correspond to object 112 (e.g., to surfaces of object 112). That is, computing device 104 can identify planar regions in the range image that correspond to object 112. For instance, in embodiments in which object 112 is a rectangular shaped box (e.g., the embodiment illustrated in FIG. 1), computing device 104 can identify two or three mutually orthogonal 15″ planar regions that correspond to surfaces (e.g., faces) of object 112 (e.g., the three surfaces of object 112 shown in FIG. 1).

Once the planar regions that correspond to object 112 have been identified, computing device 104 can determine the dimensions of object 112 based, at least in part, on the identified planar regions (e.g., on the dimensions of the identified planar regions). For example, computing device 104 can determine the dimensions of the planar regions that correspond to object 112. For instance, computing device 104 can determine the dimensions of the planar regions that correspond to object 112 based, at least in part, on the distances of the planar regions within the range image. Computing device 104 can then determine the dimensions of object 112 based, at least in part, on the dimensions of the planar regions.

Computing device 104 can identify the planar regions in the range image that correspond to object 112 by, for example, determining (e.g., calculating) coordinates (e.g., real-world x, y, z coordinates in millimeters) for each point (e.g., each row, column, and depth tuple) in the range image. Intrinsic calibration parameters associated with range camera 102 can be used to convert each point in the range image into the real-world coordinates. The system can undistort the range image using, for example, the distortion coefficients for the camera to correct for radial, tangential, and/or other types of lens distortion. In some embodiments, the two-dimensional matrix of the real-world coordinates may be downsized by a factor between 0.25 and 0.5.

Computing device 104 can then build a number of planar regions through the determined real-world coordinates. For example, a number of planar regions can be built near the points, wherein the planar regions may include planes of best fit to the points. Computing device 104 can retain the planar regions that are within a particular (e.g., pre-defined) size and/or a particular portion of the range image. The planar regions that are not within the particular size or the particular portion of the range image can be disregarded.

Computing device 104 can then upsample each of the planar regions (e.g., the mask of each of the planar regions) that are within the particular size and/or the particular portion of the range image to fit in an image of the original (e.g., full) dimensions of the range image. Computing device 104 can then refine the planar regions to include only points that lie within an upper bound from the planar regions.

Computing device 104 can then fit a polygon to each of the planar regions that are within the particular size and/or the particular portion of the range image, and retain the planar regions whose fitted polygon has four vertices and is convex. These retained planar regions are the planar regions that correspond to object 112 (e.g., to surfaces of object 112). The planar regions whose fitted polygon does not have four vertices and/or is not convex can be disregarded. Computing device 104 can also disregard the planar regions in the range image that correspond to the ground plane and background clutter of area 110.

Computing device 104 can disregard (e.g., ignore) edge regions in the range image that correspond to the edges of area 110 while identifying the planar regions in the range image that correspond to object 112. For example, computing device 104 can run a three dimensional edge detector on the range image before identifying planar regions in the range image, and can then disregard the detected edge regions while identifying the planar regions. The edge detection can also identify non-uniform regions that can be disregarded while identifying the planar regions.

Once the planar regions that correspond to object 112 have been identified, computing device 104 can determine the dimensions of object 112 based, at least in part, on the identified planar regions (e.g., on the dimensions of the identified planar regions). For example, computing device 104 can determine the dimensions of object 112 by arranging the identified planar regions (e.g., the planar regions whose fitted polygon has four vertices and is convex) into a shape corresponding to the shape of object 112, and determining a measure of centrality (e.g., an average) for the dimensions of clustered edges of the arranged shape. The dimensions of the edges of the arranged shape correspond to the dimensions of object 112.

Once the arranged shape (e.g., the bounding volume of the object) is constructed, computing device 104 can perform (e.g., run) a number of quality checks. For example, in embodiments in which object 112 is a rectangular shaped box, computing device 104 can determine whether the identified planar regions fit together into a rectangular arrangement that approximates a true rectangular box within (e.g., below) a particular error threshold.

In some embodiments, computing device 104 can include a user interface (not shown in FIG. 1). The user interface can include, for example, a screen that can provide (e.g., display and/or present) information to a user of computing device 104. For example, the user interface can provide the determined dimensions of object 112 to a user of computing device 104.

In some embodiments, computing device 104 can determine the volume of object 112 based, at least in part, on the determined dimensions of object 112. Computing device 104 can provide the determined volume to a user of computing device 104 via the user interface.

FIG. 2 illustrates a method 220 for determining dimensions associated with (e.g., of) an object in accordance with one or more embodiments of the present disclosure. The object can be, for example, object 112 previously described in connection with FIG. 1. Method 220 can be performed, for example, by computing device 104 previously described in connection with FIG. 1.

At block 222, method 220 includes capturing a range image of a scene that includes the object. The range image can be, for example, analogous to the range image previously described in connection with FIG. 1 (e.g., the range image of the scene can be analogous to the range image of area 110 illustrated in FIG. 1), and the range image can be captured in a manner analogous to that previously described in connection with FIG. 1.

At block 224, method 220 includes determining the dimensions (e.g., the length, width, height, diameter, etc.) associated with the object based, at least in part, on the range image. For example, the dimensions associated with (e.g., of) the object can be determined in a manner analogous to that previously described in connection with FIG. 1. In some embodiments, the volume of the object can be determined based, at least in part, on the determined dimensions associated with the object.

As an additional example, determining the dimensions associated with the object can include determining the dimensions of the smallest volume rectangular box large enough to contain the object based, at least in part, on the range image. The dimensions of the smallest volume rectangular box large enough to contain the object can be determined by, for example, determining and disregarding (e.g., masking out) the portion (e.g., part) of the range image containing information (e.g., data) associated with (e.g., from) the ground plane of the scene that includes the object, determining (e.g., finding) the height of a plane that is parallel to the ground plane and above which the object does not extend, projecting additional (e.g., other) portions of the range image on the ground plans, and determining (e.g., estimating) a bounding rectangle of the projected portions of the range image on the ground plane.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A system for determining dimensions of an object, comprising:
a range camera configured to produce a range image of an area in which the object is located; and
a computing device configured to determine the dimensions of the object based, at least in part, on the range image.

2. The system of claim 1, wherein the computing device is configured to:
identify a number of planar regions in the range image; and
determine the dimensions of one or more objects based, at least in part, on one or more of the planar regions.

3. The system of claim 2, wherein the number of planar regions in the range image include two or three mutually orthogonal planar regions.

4. The system of claim 1, wherein the range camera is configured to produce measurements in real-world units.

5. The system of claim 1, wherein the range camera is configured to produce measurements in relation to an index of real-world units.

6. The system of claim 1, wherein the range camera is separate from the computing device.

7. The system of claim 1, wherein the range camera and the computing device are part of a same device.

8. The system of claim 1, wherein the range camera is configured to produce the range image of the area in which the object is located while a distance between the range camera and the object is 0.75 to 5.0 meters.

9. A method for determining dimensions associated with an object, comprising:
capturing a range image of a scene that includes the object; and
determining the dimensions associated with the object based, at least in part, on the range image.

10. The method of claim 9, wherein the object is a rectangular shaped box.

11. The method of claim 9, wherein the object is cylindrically shaped.

12. The method of claim 9, wherein determining the dimensions associated with the object includes determining dimensions of a smallest volume rectangular box large enough to contain the object based, at least in part, on the range image.

13. The method of claim 12, wherein determining the dimensions of the smallest volume rectangular box large enough to contain the object includes:
determining and disregarding a portion of the range image containing information associated with a ground plane of the scene that includes the object;
determining a height of a plane that is parallel to the ground plane and above which the object does not extend;
projecting additional portions of the range image on the ground plane; and
determining a bounding rectangle of the projected portions of the range image on the ground plane.

14. A system for determining dimensions of an object, comprising:
a range camera configured to produce a range image of an area in which the object is located; and
a computing device configured to:
identify planar regions in the range image that correspond to the object; and
determine the dimensions of the object based, at least in part, on the planar regions.

15. The system of claim 14, wherein the computing device is configured to:
determine dimensions of the planar regions in the range image that correspond to the object; and
determine the dimensions of the object based, at least in part, on the dimensions of the planar regions.

16. The system of claim 15, wherein the computing device is configured to determine the dimensions of the planar regions in the range image that correspond to the object based, at least in part, on distances of the planar regions within the range image.

17. The system of claim 14, wherein the computing device is configured to identify the planar regions in the range image that correspond to the object by:
determining coordinates for each point in the range image;
building a number of planar regions near the points, wherein the planar regions include planes of best fit to the points; and
retaining the built planar regions that are within a particular size or a particular portion of the range image.

18. The system of claim 17, wherein the computing device is configured to identify the planar regions in the range image that correspond to the object by:
fitting a polygon to each of the planar regions that are within the particular size or the particular portion of the range image; and
retaining the planar regions whose fitted polygon has four vertices and is convex.

19. The system of claim 18, wherein the computing device is configured to determine the dimensions of the object by:
arranging the planar regions whose fitted polygon has four vertices and is convex into a shape corresponding to a shape of the object; and
determining a measure of centrality for dimensions of clustered edges of the arranged shape.

20. The system of claim 14, wherein the computing device is configured to:
disregard planar regions in the range image that correspond to a ground plane of the area in which the object is located; and
disregard edge regions in the range image that correspond to edges of the area in which the object is located.
